(19) United States
(12) Patent Application Publication
(10) Pub. No.: US 2013/0151688 A1
(43) Pub. Date: Jun. 13, 2013

(54) OPTIMIZATION MECHANISMS FOR LATENCY REDUCTION AND ELASTICITY IMPROVEMENT IN GEOGRAPHICALLY DISTRIBUTED DATA CENTERS

(71) Applicants: Indra WIDJAJA, Roseland, NJ (US); Simon BORST, Convent Station, NJ (US); Iraj SANIEE, New Providence, NJ (US)

(72) Inventors: Indra WIDJAJA, Roseland, NJ (US); Simon BORST, Convent Station, NJ (US); Iraj SANIEE, New Providence, NJ (US)

(73) Assignee: Alcatel-Lucent USA Inc., Murray Hill, NJ (US)

(21) Appl. No.: 13/313,730

(22) Filed: Dec. 7, 2011

(51) Int. Cl. G06F 15/16

(52) U.S. Cl. 709/224

(57) ABSTRACT

Various exemplary embodiments relate to a method for reallocating loading from a datacenter site to other datacenter sites in a cloud computing network using an objective function that defines a performance characteristic of the cloud computing network at each datacenter site and a derivative of the objective function, the method comprising: evaluating the derivative for each of a set of other datacenter sites; identifying based upon the evaluated derivatives a datacenter site in the set of datacenter sites that results in the smallest increase in the objective function; and reallocating loading among the datacenter site and the other datacenter sites based upon the evaluated derivatives and the identified other datacenter site.

### TECHNICAL FIELD

Various exemplary embodiments disclosed herein relate generally to optimization mechanisms for latency reduction and elasticity improvement in geographically distributed datacenters.

### BACKGROUND

Cloud computing is a paradigm that shifts the location of computing infrastructures (such as servers, storage and systems software) to a facility in the network in order to reduce costs. Services are delivered to end users over the Internet or generally over any other network. The facility that hosts the computing infrastructure is usually referred to as a datacenter, which is also called a cloud. The advantage of a datacenter is that computing resources may be pooled in a large scale so that it may effectively respond to instantaneous traffic demand even under unexpected events. Elasticity is the term that is usually used to describe the ability of a cloud provider to scale up or down its resources (e.g., number of servers) for a given user according to the traffic load. The resources dynamically allocated to an end user may be offered in a pay-per-use model so that the user is mainly concerned with operational expenditure and not capital expenditure.

Current prominent examples of cloud providers include Amazon EC2, Microsoft Azure and Google App Engine. Although no detailed data is publicly available, these clouds typically consist of a few large-scale datacenters located at different sites. Such datacenters having a few locations spread over a large geographic area (a country) may be called centralized datacenters. In a typical deployment, each datacenter may host tens of thousands of servers or more. These centralized datacenters may achieve elasticity and the perception of infinite capacity through statistical multiplexing. Because there may only be a few large-scale datacenters, they cannot be all located close to the end users. As a result, users located further away from a datacenter may experience unacceptable latency. With many smaller datacenters (thousands of servers or less per site), the sites may be located much closer to the end users. However, proper provisioning may not be possible or too costly with smaller datacenters when there is a spike in demand that cannot be predicted by a cloud provider.

### SUMMARY

Accordingly, techniques and methods to build a new type of cloud computing system suited for telephone company (telco) environments may be developed, because telcos and other similar service providers may provide cloud-computing using existing infrastructure. Telcos and other similar service providers may have a “last-mile” advantage. Unlike the traditional cloud-computing providers, telcos can take advantage of considerable real-estate properties of thousands of central offices (COs) to host computing infrastructures. Another advantage of the telcos may be that they also own the “last mile” and therefore have a huge advantage in offering mission-critical services that require low latency.

Further, telco based cloud-computing may be implemented using low-cost construction. Studies have investigated the electricity consumption of different components in COs. These studies show that class-5 TDM telephone switches are the largest contributor of power consumption at COs, accounting for 43% of the total equipment power consumption. These switches also tend to be bulky and take up a large area of a CO. The power consumption of a telephone switch in a typical CO is estimated to be 53 KW. If the power consumption of a server is on the order of 100 W on average, this is equivalent to hosting about 500 servers. It is well known that the widespread use of cell phones have had a huge impact on the decline of landline phones. According to the National Center for Health Statistics data as of December 2009, one out of every 4 Americans has given up her landline phone. As a result, it is likely that telephone switches will eventually be retired and may be displaced with servers, transforming a CO to also function as a small-scale or medium-scale datacenter.

Therefore, distributed datacenters appear to offer a very attractive telco cloud solution because each datacenter site may serve the end users close to it. Unfortunately, such datacenters with a small number of servers may not have the elasticity of larger cloud-computing systems. Therefore, there remains a need for distributed datacenters with load reallocation. When a given datacenter receives more demand than it can process locally, the system may reallocate a fraction of the demand to one or more remote datacenters. Because jobs that are processed by remote datacenters may incur additional round-trip time between the local and remote datacenters, the system may also choose the appropriate locations of the remote datacenters to minimize latency (response time perceived by end users) or other desired performance characteristics.

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for reallocating loading from a datacenter site to other datacenter sites in a cloud computing network using an objective function that defines a performance characteristic of the cloud computing network at each datacenter site and a derivative of the objective function, the method comprising: evaluating the derivative for each of a set of other datacenter sites; identifying based upon the evaluated derivatives a datacenter site in the set of eligible datacenter sites that results in the smallest impact in the objective function when its load fraction is incremented; and reallocating loading among the datacenter site and the other datacenter sites based upon the evaluated derivatives and the identified other datacenter site. Eligible datacenter sites (those that are allowed to send load to a given site or receive load from a given site) can include (1) all of the sites, (2) the set of neighbors, (3) the set of pre-configured sites, or (4) the set that is dynamically determined by the distributed method.

Various exemplary embodiments relate to a method for reallocating loading at a datacenter site to other datacenter sites in a cloud computing network using an objective function that defines a performance characteristic of the cloud computing network at each datacenter site and a derivative of the objective function, the method comprising: evaluating the derivative for each of a set of other datacenter sites; identifying based upon the evaluated derivatives a datacenter site in the set of eligible datacenter sites that results in the largest improvement in the objective function when its load fraction is decremented; and reallocating loading among the datacenter site and the other datacenter sites based upon the evaluated derivatives and the identified other datacenter site.

Various exemplary embodiments relate to a method for reallocating loading from a datacenter site to other datacenter sites in a cloud computing network using an objective function that defines a performance characteristic of the cloud computing network at each datacenter site and a derivative of the objective function, the method comprising: determining if the datacenter site is overloaded; if the datacenter site is overloaded then performing the following steps: evaluating the derivative for each of a set of other datacenter sites; identifying based upon the evaluated derivatives a datacenter site in the set of eligible datacenter sites that results in the largest improvement in the objective function when its load fraction is decremented; and reallocating loading among the datacenter site and the other datacenter sites based upon the evaluated derivatives and the identified other datacenter site; if the datacenter site is not overloaded performing the following steps: evaluating the derivative for each of a set of other datacenter sites; identifying based upon the evaluated derivatives a datacenter site in the set of eligible datacenter sites that results in the smallest impact in the objective function when its load fraction is incremented; and reallocating loading among the datacenter site and the other datacenter sites based upon the evaluated derivatives and the identified other datacenter site.

### BRIEF DESCRIPTION OF THE DRAWINGS

In order to better understand various exemplary embodiments, reference is made to the accompanying drawings, wherein:

FIGS. 1 and 2 illustrate a cloud system with 5 datacenters;

FIG. 3 illustrates the datacenter topology of another example;

FIG. 4 illustrates a plot of normalized delay versus utilization for the three alternatives;

FIG. 5 shows the delays of the three alternatives in each trial with load variation;

FIG. 6 is a flow chart showing the operation of the method described above; and

FIG. 7 is a flow chart showing the operation of another embodiment of a method that optimizes the object function shown in equation (1).

To facilitate understanding, identical reference numerals may be used to designate elements having substantially the same or similar structure and/or substantially the same or similar function.

### DETAILED DESCRIPTION

Jobs are processed by a datacenter differently according to their applications. In general, applications may be classified in terms of their resource requirements as: (1) processing-intensive, (2) bandwidth-intensive or (3) storage-intensive. Content delivery is an example that is both bandwidth-intensive and storage-intensive. Internet search is an example that is both processing-intensive and storage-intensive. Telco services found in the control plane are typically processing-intensive. The following embodiments focus on applications that are processing-intensive. Given that each datacenter i (i=1, . . . N), receives type-k jobs per time unit from end users, the fraction of the jobs that should be processed locally and remotely to optimize a given objective function may be determined. Different applications may involve different metrics depending on the service-level-agreement (SLA) between the user and the cloud provider. Latency may be an important metric that influences user experience and that has also been widely considered in the literature. It may be assumed that the load on each datacenter is relatively static and is known by an entity that deals with solving the optimization problem. While a specific objective function is described below directed toward minimizing a weighted average delay, other objective functions may be used to minimize or maximize any desirable performance metric or metrics.

The problem may be posed as a non-linear program with a convex objective function. The decision variable or the reallocation matrix, θ_{i,j}^{k}, denotes the fraction of load of type-k jobs that is to be reallocated from site i to site j. It is assumed that a job may be either processed by a local datacenter or a remote datacenter in its entirety. If a job is processed by a remote datacenter, there may be an additional round-trip delay for submitting the job and getting a response, denoted by τ_{i,j}, between the two sites i and j. The optimization problem that minimizes the weighted average delay may be defined as follows:

$$\begin{matrix}min {\sum }_{i} {\sum }_{j} {\sum }_{k} {\overline{λ}}_{i}^{k} {θ}_{i , j}^{k} ( {τ}_{i , j} + {Δ}_{j}^{k} ) & ( 1 ) \\ such that \\ {θ}_{i , j}^{k} \geq 0 , ∀ i , j , k & ( 2 ) \\ {\sum }_{j} {θ}_{i , j}^{k} = 1 , ∀ i , k & ( 3 ) \\ {ρ}_{j} ( {θ}_{i , j}^{k} ) \leq 1 - ɛ , ∀ j \\ where & ( 4 ) \\ {\overline{λ}}_{i}^{k} = \frac{{λ}_{i}^{k}}{{\sum }_{{i}^{′} , {k}^{′}} {λ}_{{i}^{′} , {k}^{′}}} , ∀ i , k & ( 5 ) \\ {Λ}_{j}^{k} = {\sum }_{i} {λ}_{i}^{k} {θ}_{i , j}^{k} , ∀ j , k & ( 6 ) \\ {ρ}_{j} = {\sum }_{k} {Λ}_{j}^{k} {β}_{k} / {K}_{j} & ( 7 ) \\ {Δ}_{j}^{k} = \{ \begin{matrix}\frac{{β}_{k}}{1 - {ρ}_{j}} , & multiple - server \\ \frac{{β}_{k} / {K}_{j}}{1 - {ρ}_{j}} , & single - server\end{matrix} & ( 8 )\end{matrix}$$

Constraint (2) reflects a requirement that the fractions of load reallocated should be nonnegative, while constraint (3) states the natural condition that the reallocation fractions from a given site i to all sites (including itself) should sum to 1. Constraint (4) stipulates that the utilization at site j should not exceed 1−ε to avoid overload, for a small ε>0.

Let λᵢ^{k} be the total exogenous type-k job arrival rate (also called load) from end users that are connected to site i. Equation (5) defines the corresponding normalized arrival rate at site i as the ratio of the total exogenous arrival rate at site i to the total exogenous arrival rate at all sites. Equation (6) defines the total arrival rate of jobs that are processed at site j. This accounts for jobs sent by end users connected to site j and jobs reallocated from other sites. Equation (7) defines the utilization at site j, where βₖ is the average processing time of a type-k job at a server, and Kⱼ is the number of servers at site j. Equation (8) defines the average processing delay of type-k jobs at site j for multiple-server approximation and single-server approximation. This equation assumes that the job arrival process is a Poisson process. In general, it is sufficient for Equation (8) to be any convex function of ρⱼ. For the multiple-server approximation, it is assumed that arriving jobs are perfectly load balanced across all Kⱼ servers such that each server receives a 1/Kⱼ fraction of the total load. At each server, a processor-sharing scheduler is assumed among different types of jobs. The single-server approximation provides a speed-up factor of Kⱼ to service a job. This may be used to model a job that may be divided into equal tasks and processed in parallel among the available servers in a datacenter.

Striving to optimize equation (1) may lead to a network operating system that may effectively manage resources in multiple sites. An important task of the system is to collect measurements of job arrival rates and estimate their service requirements. These measurements are updated in each interval with appropriate duration depending on load fluctuations. With a centralized computation entity, there may be a central location that gathers the measurement information and runs the optimization method in each interval to dynamically reallocate loads. An alternative may be to use a distributed method for load reallocation. Here, each site may collect the measurement information that is useful to itself.

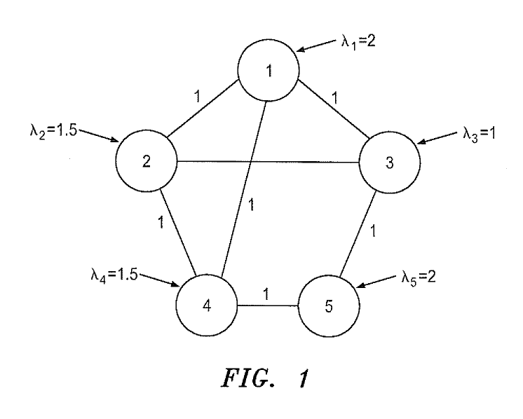

FIGS. 1 and 2 illustrate a cloud system with 5 datacenters. Described below are two examples of the two types of distributed datacenters: without load reallocation (FIG. 1) and with load reallocation (FIG. 2). FIG. 1 shows a cloud provider with 5 datacenters and their interconnects and associated round-trip delays (in time units). For the sake of clarity, it is assumed that there is one type of job and that each site has one server that can process jobs at the rate of 3 jobs per time unit. Further, assume that the exogenous job arrival rate at each site i (i=1, 2, 3, 4, 5), is given by {λ}=(2, 1.5, 1, 1.5, 2) jobs per time unit.

For the case without load reallocation, Table 1 shows the parameters values for the job arrival rate, λᵢ and the average service rate, μᵢ, at each site i. As all jobs are processed locally at their respective datacenters, there is no additional transmission delay to reallocate load and τ=0. The average delay (response time experienced by users) at each site is given in the last column. In this example, the weighted average delay is 0.8125 time units.

TABLE 1
Distributed datacenters without load reallocation

| Site | λ | μ | τ | Delay |
|---|---|---|---|---|
| 1 | 2 | 3 | 0 | 1 |
| 2 | 1.5 | 3 | 0 | 0.6667 |
| 3 | 1 | 3 | 0 | 0.5 |
| 4 | 1.5 | 3 | 0 | 0.6667 |
| 5 | 2 | 3 | 0 | 1 |

FIG. 2 describes another example of distributed datacenters with load reallocation. Table 2 shows the parameters values and the corresponding transmission delay (τ) and overall delay. Notice that while jobs arriving at sites 2, 3 and 4 are processed by their local datacenters, jobs arriving at sites 1 and 5 are divided between their local sites and the remote site 3. Specifically, a fraction θ_{1,3}=0.093 of the load from site 1 is reallocated to site 3 (reallocated load is λ₁θ_{1,3}=0.186) and the rest is processed locally at site 1. This results in a reduction of the processing delay at site 1 from the first example (without load reallocation) to 0.8432 (with load reallocation). Because site 3 handles more jobs from sites 1 and 5, its processing delay increases from 0.5 to 0.6143. Other sites 2 and 4 are unaffected. The weighted average delay with load reallocation is 0.7842 time units, which is an improvement over the example without load reallocation.

TABLE 2
Distributed datacenters with load reallocation.

| Site | λ | μ | τ | Delay |
|---|---|---|---|---|
| 1 | 1.814 | 3 | 0 | 0.8432 |
| | 0.186 | (1 → 3) | 1 | 1.6143 |
| 2 | 1.5 | 3 | 0 | 0.6667 |
| 3 | 1 | 3 | 0 | 0.6143 |
| 4 | 1.5 | 3 | 0 | 0.6667 |
| 5 | 1.814 | 3 | 0 | 0.8432 |
| | 0.186 | (5 → 3) | 1 | 1.6143 |

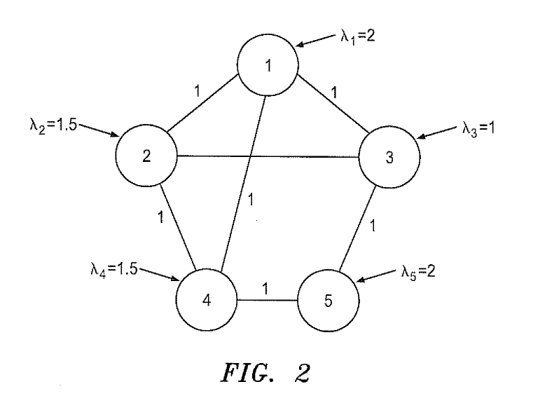

Below the performance in another example of a different cloud alternative is evaluated. FIG. 3 illustrates the datacenter topology of another example. The average round-trip delay between two sites is shown as a number in some time unit. It is assumed that the datacenter location is at CHI for the centralized cloud. This location gives the lowest weighted average delay for the centralized cloud when transmission delays dominate processing delays. FIG. 3 includes 32 datacenter sites and 44 datacenter interconnects. Each link (i, j) is associated with its τ_{i,j}.

For this example, three alternatives are compared: (1) a centralized datacenter with servers located in one site, (2) distributed datacenters without load reallocation and (3) distributed datacenters with load reallocation. It is assumed that there is one type of job and the average job service time is β=1 time unit and the number of servers is Kⱼ=K for all j. For the centralized datacenter, the number of servers is NK, where N=32. We use the multiple-server approximation in the evaluation.

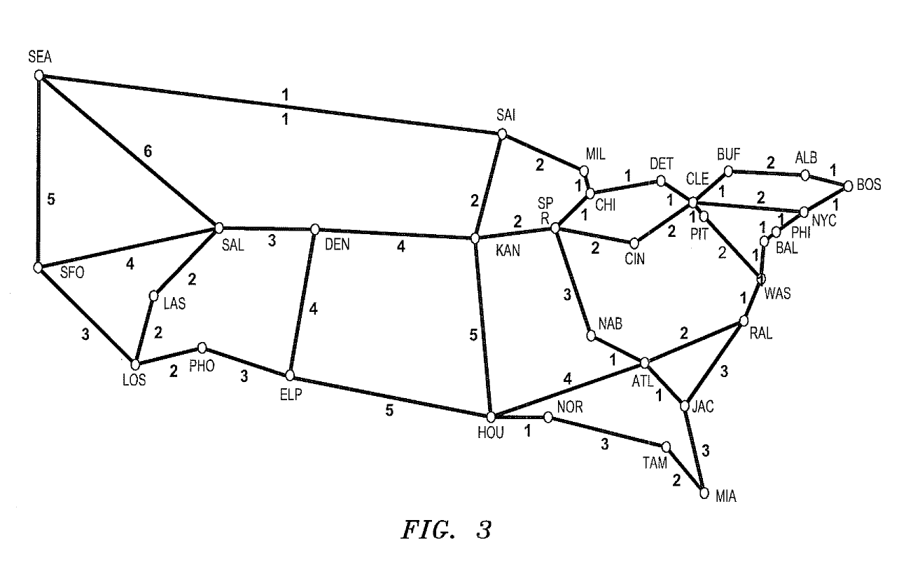

FIG. 4 illustrates a plot of normalized delay versus utilization for the three alternatives. From FIG. 4 it is easily deduced that distributed datacenters with and without load reallocation will have the same performance when the job arrival rates and numbers of servers are uniform; that is, λᵢ=λ, K_i=K, for all i. To experiment with a more realistic non-uniform load patterns, a simple load pattern where the arrival rates at half of the sites are reduced and the other half are increased by the same amount may be adopted. The motivation is to ensure that the total arrival rate stays the same (assuming that the number of sites is even). For example, λᵢ=(1+δ)λ, if i is odd and λᵢ=(1−δ)λ, if i is even.

For the distributed datacenters without load reallocation, the utilization at site j is ρⱼ=λⱼβ/Kⱼ=λⱼ/K, for Kⱼ=K and β=1. Therefore, the utilizations at different sites may vary when the loads are non-uniform. With load reallocation, the utilization at site j is given by equation (7). Although load reallocation may attempt to minimize the weighted delay, the utilizations at different sites are generally fairly balanced. For the centralized datacenter, the total arrival rate is Σᵢ₌₁^{N}λᵢ=Nλ and the total service rate is Σᵢ₌₁^{N}Kᵢ/β=NK, for Kⱼ=K and β=1. The utilization at the centralized datacenter is λ/K. In other words, variation in loads at different sites may not affect the utilization at the centralized server if the total load is the same.

FIG. 4 compares the weighted average delays as λ is varied for the three alternatives when the loads are non-uniform (δ=0.5). For better visualization, the utilization of the centralized datacenter, ρ=λ/K, for the x-axis may be used so that it becomes dimensionless and independent of K. As commonly believed, distributed datacenters generally achieve lower delay than the centralized counterparts due to their close proximity to the end users. The centralized version only becomes better when utilization is very high and processing delay dominates transmission delay between sites. Interestingly, observe that the distributed datacenters with load reallocation may achieve lower delay than the centralized version even at very high utilization. On the other hand, distributed datacenters without load reallocation perform very poorly as the delay becomes unbounded very quickly.

One of the most attractive benefits of cloud computing is the ability to scale resources up or down dynamically and allow users to believe that the cloud resources are unlimited. Obviously, more servers deployed in a datacenter improve the elasticity. While it may be common to deploy a large number of servers in a centralized datacenter, it may become uneconomical with distributed datacenters for a large number of sites. Moreover, for a telco datacenter located in a typical CO, the power and real-estate constraints will generally prohibit deployment of a larger number of servers.

To evaluate elasticity of the three alternatives, we perform the following experiment. In each trial, a load λᵢ may be independently generated for each site i according to a uniform distribution over [λₘᵢₙ,λₘₐₓ]. After the load for each site has been generated, the loads for a given utilization may be rescaled.

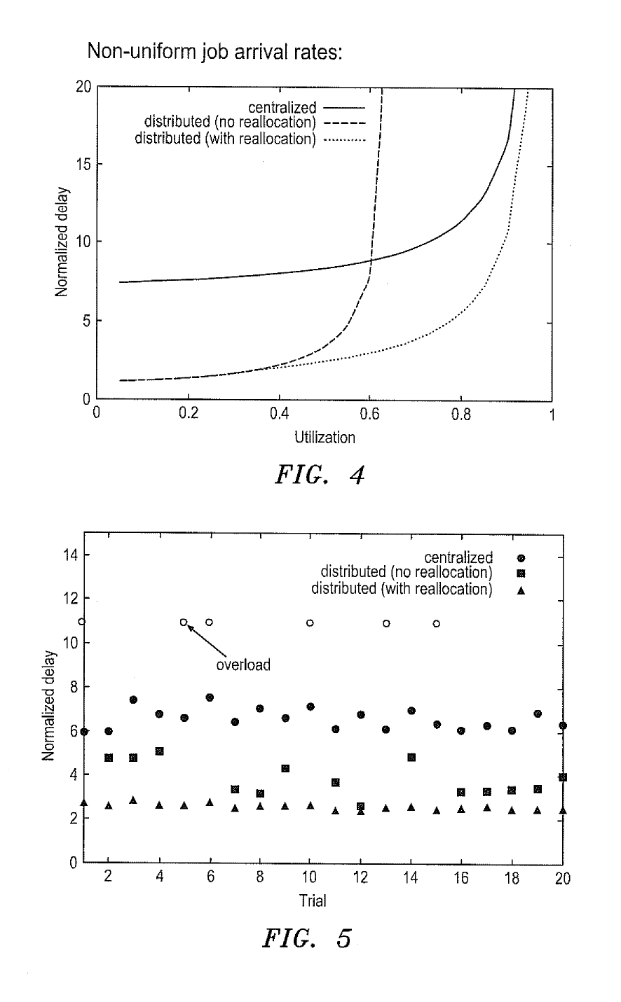

FIG. 5 shows the delays of the three alternatives in each trial with load variation (λₘᵢₙ=0,λₘₐₓ=1.5). Note that while distributed datacenters with load reallocation may maintain consistent user experience in terms of delays, the other alternatives experience wide fluctuation of delays. The centralized datacenter may experience large fluctuation because large demand on a site far away from the datacenter may contribute significantly to the overall delay. The distributed datacenters without load reallocation may not provide elasticity because it may suffer from occasional overload when the job arrival rate exceeds the service capacity of the site.

The use of a centralized method for optimizing the load reallocation in any typical network, may prove to be difficult because of the large amount of processing required to optimize the network for a large number of datacenters and the need to collect information from each of the datacenters to perform the optimization. Therefore, a distributed method implemented at a datacenter using a minimal amount of information from the other datacenters would be beneficial.

A distributed method for solving the optimization problem as outlined in equations (1)-(8), i.e., finding the optimal load reallocation fractions θ*={θᵢⱼ^{k}*} will now be described. For convenience, the scenario with just a single job type is described and the superscript k is suppressed, but the method easily extends to the case of several job types. It may be assumed that

$${\sum }_{i = 1}^{N} {λ}_{i} β < {\sum }_{j = 1}^{N} ( 1 - ɛ ) {K}_{j}$$

to ensure that a feasible solution exists.

In general, the method seeks to maximize or minimize the objective function using a distributed method carried out by each datacenter. In the present example the objective function to be minimized is the weighted average delay. Other objective functions based upon various parameters may also be used.

In one embodiment, the high-level operation of the method may be described as follows. At each iteration, each site i may calculate what the increase δᵢⱼ in the global objective function (the weighted average delay) would be if it were to send an additional infinitesimal fraction of load to any site j (including site i itself, which would amount to keeping more load at site i itself). Each site i then may determine for which site j the increase in the global objective function is minimum, let us say jmin(i). Next, site i may decrease the fraction of load reallocated to all sites other than jmin(i) by a “small” amount that may be proportional to δᵢⱼ, and at the same time may increase the fraction of load reallocated to site jmin(i) by an amount that is equal to the total reduction of the load reallocated to all other sites. As a result, the global objective function may be reduced at each iteration, provided that the step size is “not too small”, until eventually the optimum is reached and the step size reduces to zero. This method may be described as using a “min-rule” method.

A more detailed specification of the operation of the method may be described as follows. Starting from an arbitrary (feasible) initial solution θ(0), the method may produce a sequence of solutions θ(1), θ(2), . . . , with θ(t)→θ* as t→∞. It may be noted here that θ* may not be unique.

Specifically, in order to obtain θ(t+1) from θ(t), the method may first calculate a derivative of the objective function described in equation (1) with respect to θ_{i,j}::

$${α}_{ij} ( t ) = {λ}_{i} [ {τ}_{ij} + \frac{{βΓ}_{j}}{{( 1 - {ρ}_{j} ( θ ( t ) ) )}^{2}} ] ,$$

with Γⱼ≡1 in the multiple-server approximation and Γⱼ=1/Kⱼ in the single-server approximation, then may determine j min(i)=argminⱼαᵢⱼ, and for each i may calculate γᵢⱼ=α_{i,j}−α_{i,j min(i)}, where here we suppress the update time “t” to simplify the notation. In addition, the method may compute for each j, j=1, . . . , N

$$δ = min \{ κ , ( 1 - {ρ}_{j min ( i )} ) {K}_{j min ( i )} / ( {λ}_{i} {\overline{βγ}}_{i} ) \} , \\ where$$

$$\overline{{γ}_{i}} = {\sum }_{j \neq j min ( i )} {γ}_{ij} .$$

Then, the method may calculate θᵢⱼ(t+1)=θ(t)−ηᵢⱼ(t), with ηᵢⱼ(t)=min{θᵢⱼ(t),δγᵢⱼ(t)} for all j≠j min(i), κ>0, and

$${η}_{{ij}_{i} ( t )} = - {\sum }_{j \neq j min ( i )} {η}_{ij} ( t ) .$$

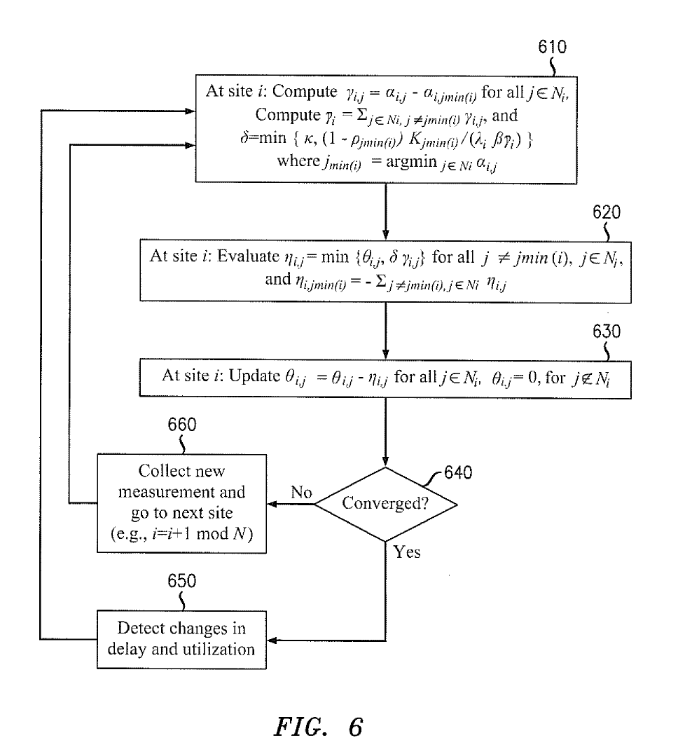

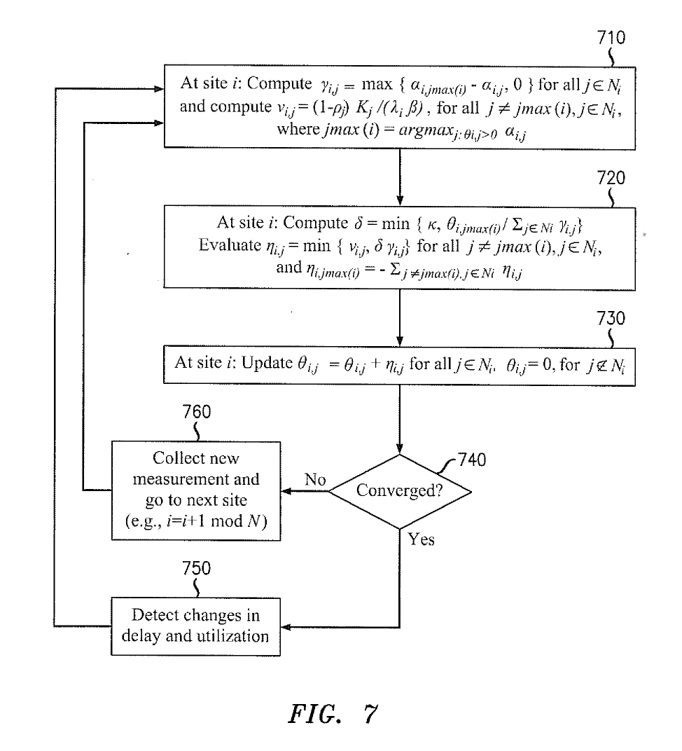

η is a reallocation adjustment matrix that reflects the shifting of loading from one site to another. The overall method is described in FIG. 6 and an alternative “max-rule” method is described in FIG. 7.

Note that the method may operate in a largely distributed manner because it suffices for each site j to advertize the value of ρⱼ(θ), so that each site i may then determine the values of αᵢⱼ(t), j min(i) and η_{ijl (t) based on these values in conjunction with the τ}ᵢⱼ values.

Further observe that in general

$$j min ( i ) \neq arg min [ {τ}_{ij} + \frac{{βΓ}_{j}}{1 - {ρ}_{j} ( θ ( t ) )} ] ,$$

i.e., it is generally not optimal for site i to send traffic to the site that offers minimum delay, because it should also account for the impact on other nodes, as captured by the last term in the above expression for the partial derivative. At low load, i.e., ρⱼ<<1, j=1, . . . N, the link latencies may dominate, and j min(i)=argminⱼτᵢⱼ=i, i.e., the traffic may be served locally. At high load, i.e., ρⱼ↑1, j=1, . . . N, the processing delays may dominate, and
j min(i)=argminⱼρⱼ(θ(t)),
i.e., the traffic may be routed to the site with the minimum relative load.

An initial solution may be generated in various ways, e.g.,

$${θ}_{ii} ( 0 ) = min \{ \frac{\overline{ρ} {K}_{i}}{{λ}_{i} β} , 1 \} , \\ With$$

$$\overline{ρ} = \frac{{\sum }_{i} {λ}_{i} β}{{\sum }_{j} {K}_{j}} < 1$$

representing the system-wide average normalized load, and

$${θ}_{ij} ( 0 ) = ( 1 - {θ}_{ii} ( 0 ) ) \frac{{\overline{μ}}_{j}}{{\sum }_{l = 1}^{N} {\overline{μ}}_{l}} , \\ j \neq i ,$$

with μ̅ⱼ= ρ̅Kⱼ−λⱼβθⱼⱼ(0)=max{ ρ̅Kⱼ−λⱼβ,0}, representing the residual capacity at node j in excess of its local traffic, if any, when carrying its fair share of the total load.

FIG. 6 is a flow chart showing the operation of the method described above. Specifically, the method shown in the flowchart reallocates computing load using a “min-rule” method. The “min-rule” seeks to compute at a datacenter i the derivative function α_{i,j} for each j 610. The minimum α_{i,j} across j is determined. Then γ_{i,j}=α_{i,j}−α_{i,jmin(i)} is calculated for each j 610. Then vⱼ may be calculated 610. These calculations identify the site j where an increase in load fraction impacts the overall value of the objective function the least. Once, this site is identified, a “small” amount of the loading at the other sites may be moved to the site j. This may be accomplished by steps 620 and 630. At 620 may be calculated. The value η_{i,j} is then used to update θ_{i,j} 630 that has the effect of shifting the loads among the sites. This process may be repeated until the method converges on a solution for θ_{i,j} 640. If the solution converges, then the method determines when changes in delay and utilization have occurred that require further reallocation 650. If the solution has not converged, then new measurements may be collected and the computation continues for the next site 660. Ideally, the solution will converge when the computation of η_{i,j} becomes 0 for each j in the eligible set. Convergence may typically take too many iterations due to noisy measurement. Accordingly, when η_{i,j} reaches a very small threshold value, the method may determine that it has converged on a solution. It is worth noting that newly updated measurements that need to be collected at datacenter i are the utilization ρⱼ values of the eligible sites with respect to i and the local job arrival rate λᵢ. Other values such as β, Kⱼ, Γⱼ and τ_{i,j} are generally gathered once or when there is a change in value that should occur extremely rarely.

FIG. 7 is a flow chart showing the operation of another embodiment of a method that optimizes the object function shown in equation (1). Specifically, the method shown in the flowchart reallocates computing load using a “max-rule” method. The “max rule” seeks to compute at a datacenter i the derivative function α_{i,j} for each j 710. The maximum α_{i,j}, across j such that θᵢⱼ>0, is determined. Then γ_{i,j}=max{α_{i,jmax(i)}−α_{i,j},0} is calculated for each j 710. Then vⱼ may be calculated 710. These calculations identify the site j where a decrease in load fraction improves the overall value of the objective function the most. Once, this site is identified, a “small” amount of the loading from site j may be moved to the other sites. This may be accomplished by steps 720 and 730. At 720 η_{i,j} may be calculated. The value η_{i,j} is then used to update θ_{i,j} 730 that has the effect of shifting the loads among the sites. This process may be repeated until the method converges on a solution for optimal θ_{i,j} 740. If the solution converges, then the method determines when changes in delay and utilization have occurred that require further reallocation 750. If the solution has not converged, then new measurements may be collected and the computation continues for the next site 760. Ideally, the solution will converge when the computation of η_{i,j} becomes 0, but in reality this may take many iterations to achieve. Accordingly, when η_{i,j} reaches a small threshold value, the method may determine that it has converged on a solution.

In the methods described above, a site i may look to reallocate loading to or from other sites j. The methods as described above may consider all other sites j to be eligible for load reallocation. In another embodiment, only a subset of other sites j may be considered eligible for load reallocation. For example, at site i only neighboring datacenters, datacenters within a certain distance, or datacenters defined by network policies may be used in seeking to reallocate loading. This may have the benefit of decreasing the amount of information that site i may be required to collect and to reduce the amount of reallocation processing. Further, because distant sites may have a long delay due to travel time, it is unlikely that traffic would ever by reallocated to distant sites, so this may prevent unnecessary computation. Multiple job types can also be easily incorporated in the above methods.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for reallocating loading from a datacenter site to other datacenter sites in a cloud computing network using an objective function that defines a performance characteristic of the cloud computing network at each datacenter site and a derivative of the objective function, the method comprising:
evaluating the derivative for each of a set of other datacenter sites;
identifying based upon the evaluated derivatives a datacenter site in the set of eligible datacenter sites that results in the smallest impact in the objective function when its load fraction is incremented; and
reallocating loading among the datacenter site and the other datacenter sites based upon the evaluated derivatives and the identified other datacenter site.

2. The method of claim 1, further comprising after reallocating loading, determining if the reallocation has converged to a reallocation solution.

3. The method of claim 2, wherein if the reallocation has not converged to a reallocation solution, repeating evaluating the derivative, identifying a datacenter site, reallocating loading, and determining if the reallocation has converged.

4. The method of claim 2, wherein determining if the reallocation has converged to a reallocation solution includes:
calculating a plurality of differences between the derivative for the identified datacenter site and the derivative for each of the other datacenter sites; and
determining if each of the plurality of differences is below a threshold.

5. The method of claim 1, wherein if the datacenter site detects a change in delay or utilization, repeating evaluating the derivative, identifying a datacenter site, reallocating loading, and determining if the reallocation has converged.

6. The method of claim 1, wherein
a reallocation matrix defines the reallocation of loading between the datacenter site and the other datacenter sites, and
reallocating loading includes calculating a reallocation adjustment matrix and summing the reallocation matrix and the reallocation adjustment matrix.

7. The method of claim 1, wherein evaluating the derivative includes:
receiving a load parameter from each of the set of other datacenter sites;
receiving a service rate parameter from each of the set of other datacenter sites; and
receiving a delay parameter for each of the other datacenter sites that defines a delay between the datacenter site and each of the other datacenter sites,
wherein the evaluated derivative is based upon the load parameter, service rate parameter, and delay parameter.

8. The method of claim 1, further comprising calculating an initial reallocation matrix that defines the reallocation of loading between the datacenter site and the other datacenter sites.

9. The method of claim 1, wherein the set of other datacenters sites is one of:
all other datacenter sites within a specified distance of the datacenter site;
all other datacenter sites that are neighbors to the datacenter site;
all other datacenter sites identified by a network policy; and
all other datacenter sites.

10. A method for reallocating loading at a datacenter site to other datacenter sites in a cloud computing network using an objective function that defines a performance characteristic of the cloud computing network at each datacenter site and a derivative of the objective function, the method comprising:
evaluating the derivative for each of a set of other datacenter sites;
identifying based upon the evaluated derivatives a datacenter site in the set of eligible datacenter sites that results in the largest improvement in the objective function when its load fraction is decremented; and
reallocating loading among the datacenter site and the other datacenter sites based upon the evaluated derivatives and the identified other datacenter site.

11. The method of claim 10, further comprising after reallocating loading, determining if the reallocation has converged to a reallocation solution.

12. The method of claim 11, wherein if the reallocation has not converged to a reallocation solution, repeating evaluating the derivative, identifying a datacenter site, reallocating loading, and determining if the reallocation has converged.

13. The method of claim 11, wherein determining if the reallocation has converged to a reallocation solution includes:
calculating a plurality of differences between the derivative for the identified datacenter site and the derivative for each of the other datacenter sites; and
determining if each of the plurality of differences is below a threshold.

14. The method of claim 10, wherein if the datacenter site detects a change in delay or utilization, repeating evaluating the derivative, identifying a datacenter site, reallocating loading, and determining if the reallocation has converged.

15. The method of claim 10, wherein
a reallocation matrix defines the reallocation of loading between the datacenter site and the other datacenter sites, and
reallocating loading includes calculating a reallocation adjustment matrix and summing the reallocation matrix and the reallocation adjustment matrix.

16. The method of claim 10, wherein evaluating the derivative includes:
receiving a load parameter from each of the set of other datacenter sites;
receiving a service rate parameter from each of the set of other datacenter sites; and
receiving a delay parameter for each of the other datacenter sites that defines a delay between the datacenter site and each of the other datacenter sites,
wherein the evaluated derivative is based upon the load parameter, service rate parameter, and delay parameter.

17. The method of claim 10, further comprising calculating an initial reallocation matrix that defines the reallocation of loading between the datacenter site and the other datacenter sites.

18. The method of claim 10, wherein the set of other datacenters sites is one of:
all other datacenter sites within a specified distance of the datacenter site;
all other datacenter sites that are neighbors to the datacenter site;
all other datacenter sites identified by a network policy; and
all other datacenter sites.

19. A method for reallocating loading from a datacenter site to other datacenter sites in a cloud computing network using an objective function that defines a performance characteristic of the cloud computing network at each datacenter site and a derivative of the objective function, the method comprising:
determining if the datacenter site is overloaded;
if the datacenter site is overloaded then performing the following steps:
evaluating the derivative for each of a set of other datacenter sites;
identifying based upon the evaluated derivatives a datacenter site in the set of eligible datacenter sites that results in the largest improvement in the objective function when its load fraction is decremented; and
reallocating loading among the datacenter site and the other datacenter sites based upon the evaluated derivatives and the identified other datacenter site;
if the datacenter site is not overloaded performing the following steps:
evaluating the derivative for each of a set of other datacenter sites;
identifying based upon the evaluated derivatives a datacenter site in the set of eligible datacenter sites that results in the smallest impact in the objective function when its load fraction is incremented; and
reallocating loading among the datacenter site and the other datacenter sites based upon the evaluated derivatives and the identified other datacenter site.

20. The method of claim 19 further comprising, determining again if the datacenter site is overloaded before the step of if the datacenter site is not overloaded performing the following steps.
